(19) United States
(12) Patent Application Publication
(10) Pub. No.: US 2022/0027041 A1
(43) Pub. Date: Jan. 27, 2022

(54) GRAPHICAL USER INTERFACE CONTROL FOR DUAL DISPLAYS

(71) Applicant: Microsoft Technology Licensing, LLC, Redmond, WA (US)

(72) Inventors: Katherine Mary EVERITT, Seattle, WA (US); Robert Steven MEYER, Seattle, WA (US); Benjamin Franklin CARTER, Redmond, WA (US); Stanley Roger AYZENBERG, Seattle, WA (US); William Scott STAUBER, Seattle, WA (US); Lauren Eileen EDELMEIER, Seattle, WA (US); Roberth KARMAN, Seattle, WA (US); Ruediger Albert KINAST, Seattle, WA (US); Stephanie Lauren Grace HASHAM, Kirkland, WA (US)

(73) Assignee: Microsoft Technology Licensing, LLC, Redmond, WA (US)

(21) Appl. No.: 16/939,957

(22) Filed: Jul. 27, 2020

(51) Int. Cl. G06F 3/0484; G06F 3/0488; G06Q 10/10; H04L 12/58; G06F 1/16

(52) U.S. Cl. CPC G06F 3/04845; G06F 3/04883; G06F 1/1622; H04L 51/04; G06Q 10/1093

(57) ABSTRACT

A computing device includes a first portion comprising a first display, and a second portion comprising a second display. The second portion is rotatably connected to the first portion. The computing device executes a program comprising a context user interface and a focus user interface. The focus user interface is configured to provide a more detailed view of a selected item from the context user interface. When the computing device is in a double-portrait orientation, the context user interface is displayed on the first display. Upon receipt of a spanning user input, the computing device displays the context user interface on the first display and the focus user interface on the second display. Upon detecting a rotation to a double-landscape orientation, the computing device displays the focus user interface on the first display and second display.

### BACKGROUND

Some mobile electronic devices, such as smart phones and tablets, have a monolithic handheld form in which a display occupies substantially an entire front side of the device. Other devices, such as laptop computers, include a hinge that connects a display to other hardware, such as a keyboard and cursor controller (e.g. a track pad). Some handheld display devices may be rotated by the user to a different orientation in order to view content in a desired format.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

A computing device includes a first portion comprising a first display and a second portion comprising a second display.

In an example, the computing device executes a program comprising a context user interface and a focus user interface. The focus user interface is configured to provide a more detailed view of a selected item from the context user interface. When the computing device is in a double-portrait orientation, the computing device displays the context user interface on the first display. Upon receipt of a spanning user input, the computing device displays the context user interface on the first display and the focus user interface on the second display. The computing device detects a rotation of the computing device to a double-landscape orientation, and upon detecting the rotation, displays the focus user interface on the first display and second display.

In another example, the computing device displays a user interface of a calendar program and an inking interface. The computing device receives an inking input via the inking interface, and receives an input moving the inking input from the inking interface to a destination position within the user interface of the calendar program. Based upon the destination position and the inking input, the computing device creates a calendar item.

### BRIEF DESCRIPTION OF THE DRAWINGS

FIG. 1 shows an example dual display computing device.

FIGS. 2-5 show example poses of the dual display computing device of FIG. 1.

FIG. 6 shows a flow diagram of an example method of displaying a graphical user interface based on a pose of a dual display computing device.

FIG. 7 shows example graphical user interfaces being displayed according to a variety of different display modes for a variety of different poses of the dual display computing device of FIG. 1.

FIG. 8 shows example graphical user interfaces being displayed for a hardware or software keyboard that is engaged with respect to the computing device of FIG. 1.

FIG. 9 shows a flow diagram of an example method of displaying a context user interface and a focus user interface on the computing device of FIG. 1 based on a user input and rotation of the computing device.

FIG. 10 shows an example of a context user interface and a focus user interface of an email or messaging application program.

FIG. 11 shows an example graphical user interface of a calendar program for which a calendar item is created or modified by an inking input.

FIG. 12 shows a flow diagram of an example method of creating or modifying a calendar item by using an inking input.

FIG. 13 shows a schematic diagram of an example computing system.

### DETAILED DESCRIPTION

A variety of hand-held or mobile computing devices include displays by which graphical content may be displayed in a portrait mode or a landscape mode depending on an orientation of the device. These devices may include sensors to detect the orientation of the device through rotation and/or the gravity vector. Some computing devices include or support the use of multiple displays. For example, some computing devices include two displays that are joined in a hinged configuration that enables a first display to be rotated relative to a second display of the device.

The present disclosure provides examples of controlling the presentation of graphical user interfaces across multiple displays of a computing device or computing system. In an example, a computing device having two displays executes a program comprising a context user interface and a focus user interface. The focus user interface is configured to provide a more detailed view of a selected item from the context user interface. The focus user interface and the context user interface may be selectively displayed by the computing device responsive to a pose of the computing device and other user inputs.

As an example, when the computing device is in a double-portrait orientation in which its two displays are in a side-by-side configuration, the computing device may display the context user interface of the program on a first display while a second display of the computing device displays a user interface of a different program. Upon the computing device receiving a spanning user input, for example, the computing device displays the context user interface on the first display and the focus user interface on the second display, thereby enabling a user to selectively extent a particular interface of the program to an additional display. This configuration may enable a user to interact with the focus user interface on one display, while referring to contextual information of the context user interface on the other display.

As another example, the computing device may detect a rotation of the computing device from a portrait orientation to a double-landscape orientation. Upon detecting the rotation, the computing device may display the focus user interface on the first display and the second display, thereby enabling a user to selectively utilize a particular user interface of the program across both the first display and the second display. As described in further detail herein, additional display modes of the program may be accessed by the user by changing a pose of the computing device or by providing a user input.

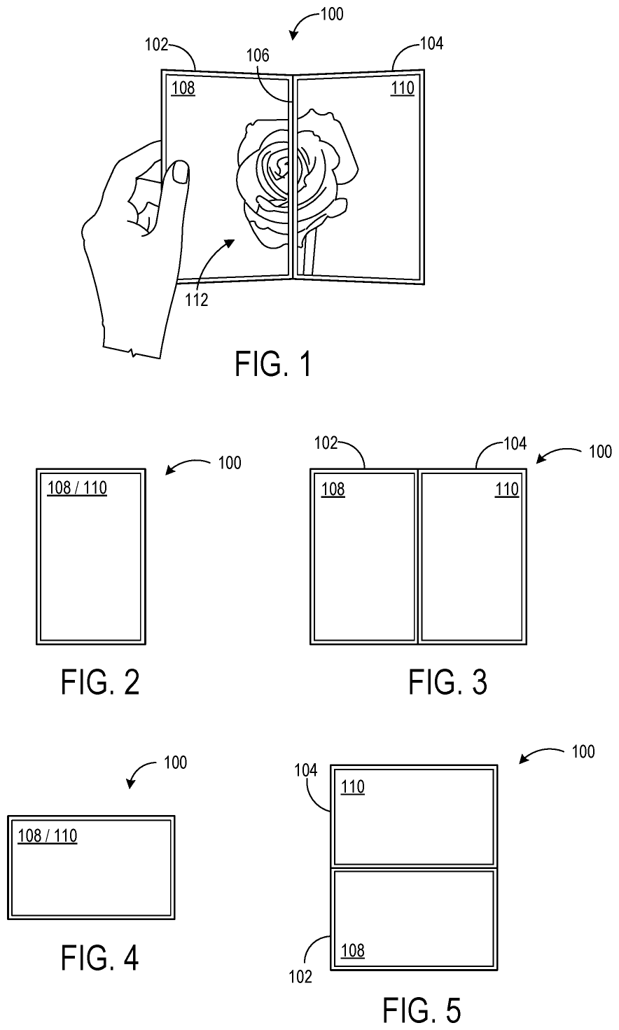

FIG. 1 shows an example dual display computing device 100. Computing device 100 includes a first portion 102 and a second portion 104 that is rotatably connected to the first portion via a hinge 106. First portion 102 comprises a first display 108 and second portion 104 comprising a second display 110. In this example, first display 108 and second display 110 collectively display graphical content 112 that spans hinge 106. Hinge 106 enables first portion 102 and its respective first display 108 to be rotated relative to second portion 104 and its respective second display 110 to provide a variety of different postures or poses for the computing device as described in further detail with reference to FIGS. 2-5. In this example, hinge 106 defines a seam between first display 108 and second display 110. However, first display 108 and second display 110 may instead form regions of a common display defining a viewable region that is uninterrupted by hinge 106. Computing device 100 may take any suitable form, including hand-held and/or mobile devices such as a foldable smart phone, tablet computer, laptop computer, etc.

First display 108 and second display 110 may be touch-sensitive displays having respective touch sensors. For example, first portion 102 may further comprise a first touch sensor for first display 106, and second portion 104 may further comprise a second touch sensor for second display 108. These touch sensors may be configured to sense one or more touch inputs, such as one or more digits of a user and/or a stylus or other suitable implement manipulated by the user, including multiple concurrent touch inputs.

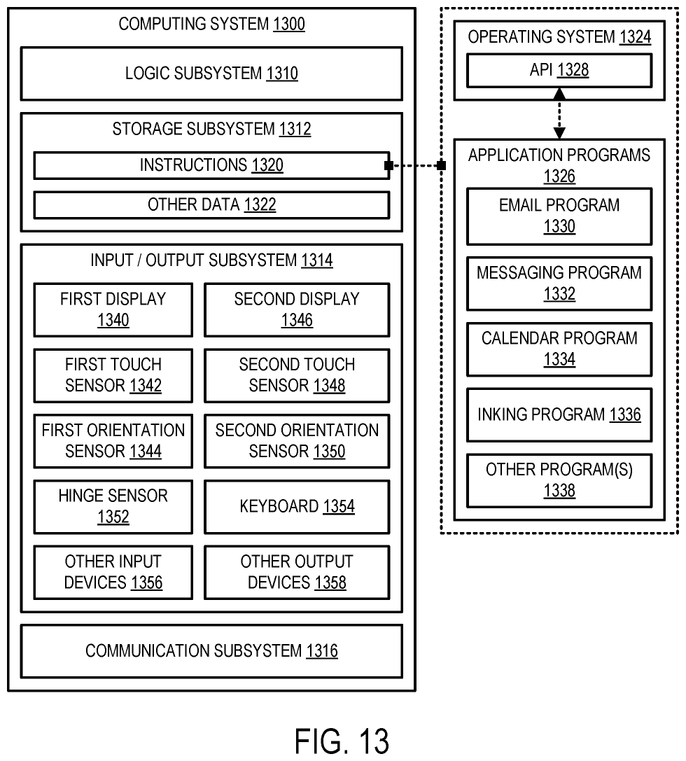

Computing device 100 may include one or more sensors by which a pose of the computing device may be determined. For example, first portion 102 may include a first orientation sensor by which an orientation of the first portion may be determined, and second portion 104 may include a second orientation sensor by which an orientation of the second portion may be determined. Computing device 100 alternatively or additionally may include a hinge sensor by which a relative angle between first portion 102 and second portion 104 may be determined. Example sensors of computing device 100 are described in further detail with reference to FIG. 13.

FIGS. 2-5 show example poses of computing device 100 of FIG. 1. FIG. 2 shows an example of computing device 100 in a single-portrait pose in which first display 108 and second display 110 are in a back-to-back or folded configuration, enabling one of first display 108 or second display 110 to be viewed from a given perspective. FIG. 3 shows computing device 100 in a double-portrait pose in which first display 108 and second display 110 are in a side-by-side or unfolded configuration, enabling both first display 108 and second display 110 to be viewed from a given perspective. Graphical content may be displayed via first display 108 and/or second display 110 according to a portrait orientation in the single-portrait pose of FIG. 2 and the double-portrait pose of FIG. 3.

FIG. 4 shows computing device 100 in a single-landscape pose in which in which first display 108 and second display 110 are in a back-to-back or folded configuration, enabling one of first display 108 or second display 110 to be viewed from a given perspective. FIG. 5 shows computing device 100 in a double-landscape pose in which first display 108 and second display 110 are in a side-by-side or unfolded configuration, enabling both first display 108 and second display 110 to be viewed from a given perspective. Graphical content may be displayed via first display 108 and/or second display 110 according to a landscape orientation in the single-landscape pose of FIG. 4 and the double-landscape pose of FIG. 5.

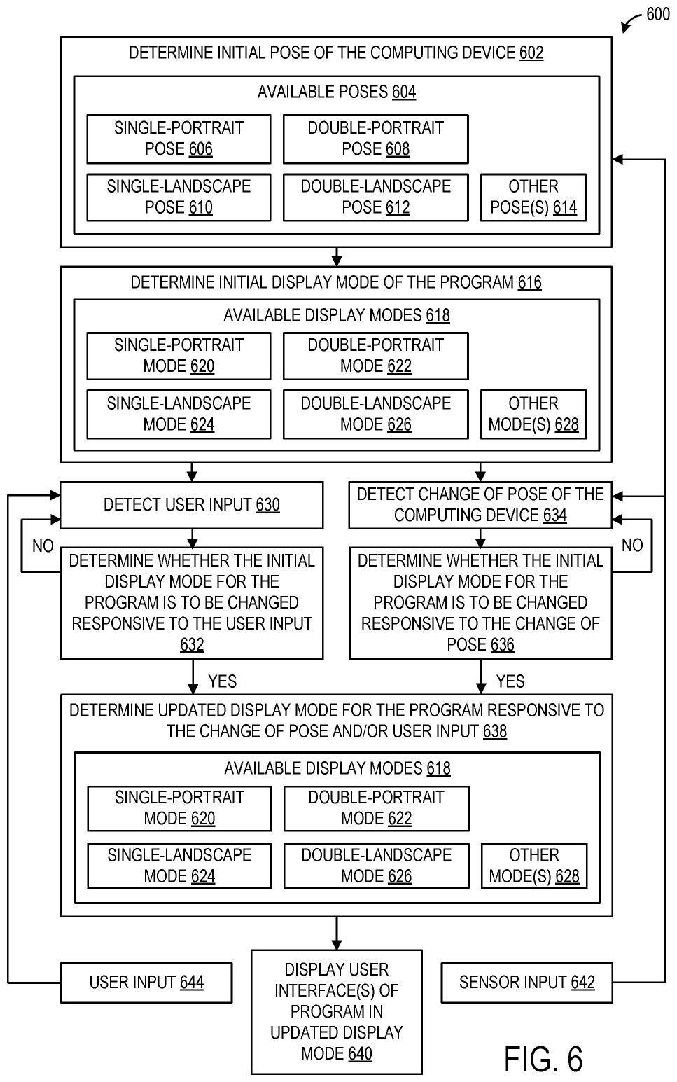

FIG. 6 shows a flow diagram of an example method 600 of displaying a graphical user interface based on a pose of a dual display computing device. Method 600 may be performed by computing device 100 of FIG. 1, as an example.

At 602, an initial pose of the computing device is determined from among a set of available poses 604. For example, the computing device may classify its current pose into one of a plurality of available poses 604 based on sensor input 642 received from one or more sensors. Sensors from which sensor input 642 may be received include one or more orientation sensors and/or hinge sensors of the computing device. Sensor input 642 may be continuously received or periodically sampled by the computing device to determine its pose or a change in pose.

In this example, the set of available poses 604 includes a single-portrait pose 606 (e.g., as shown in FIG. 2), a double-portrait pose (e.g., as shown in FIG. 3), a single-landscape pose 610 (e.g., as shown in FIG. 4), a double-landscape pose 612 (e.g., as shown in FIG. 5), and one or more other poses 614. In at least some examples, the computing device may reference a set of predefined pose definitions to determine the initial pose of the computing device. These pose definitions may define a respective range of orientations and/or hinge angles for each pose of the set of available poses 604.

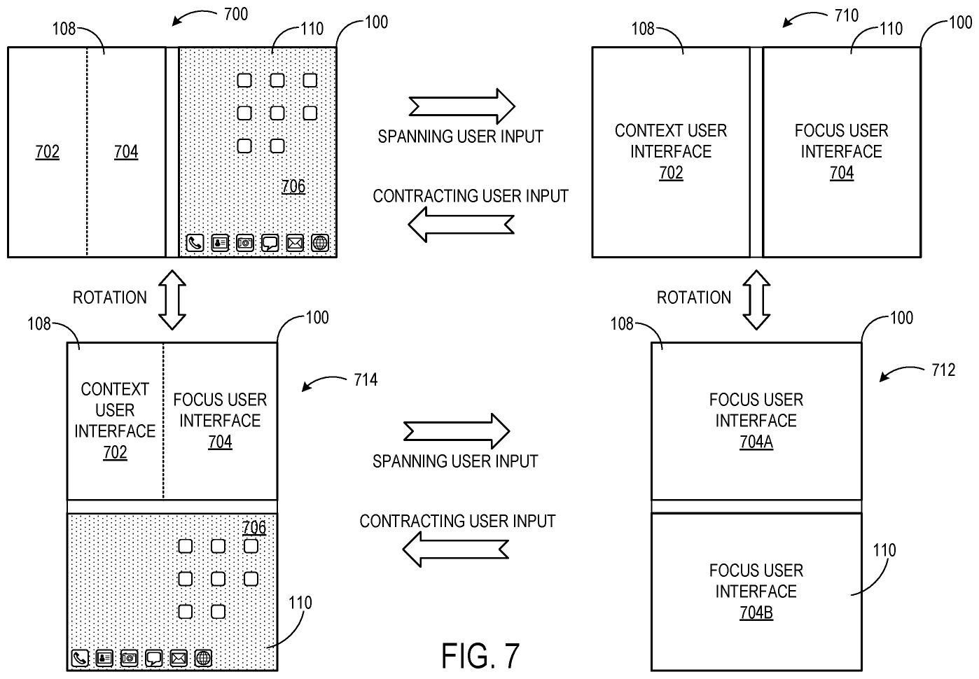

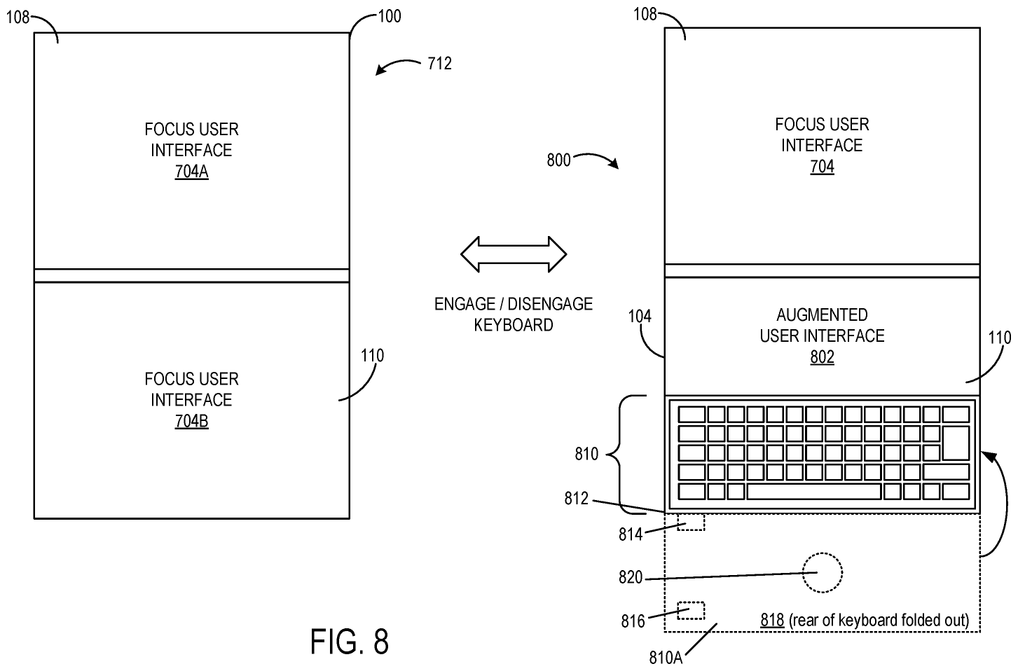

At 616, an initial display mode of a subject program executed by the computing device is determined from among a set of available display modes 618. The subject program may, for example, take the form of an application program, such as a communication program comprising one or more of a messaging program (e.g. email and/or instant messaging), calendar program, etc. In this example, the set of available display modes 616 includes a single-portrait mode 620 (e.g., as shown in example 700 of FIG. 7), a double-portrait mode 622 (e.g., as shown in example 710 of FIG. 7), a single-landscape mode 624 (e.g., as shown in example 714 of FIG. 7), a double-landscape mode 626 (e.g., as shown in example 712 of FIG. 7), and one or more other display modes 628 (e.g., the keyboard display mode of FIG. 8).

In at least some examples, the computing device may reference a set of predefined relationship definitions between poses and display modes to determine the initial display mode of the subject program. These relationship definitions may prescribe one or more display modes of the set of available display modes 618 for each of pose of the set of available poses 604. Accordingly, each of available poses 604 may be associated with one, two, or more different display modes of the set of available display modes 618.

In at least some examples, determining a pose of the computing device, such as at 602, may be performed by a program other than the subject program for which the display mode is determined at 616. For example, an operating system executed by the computing device may determine the pose of the computing device, which may then inform the display mode of an application program executed by the computing device within an operating environment of the operating system. However, in other examples, the subject program for which the display mode is determined at 616 may determine the pose of the computing device at 602.

Furthermore, in at least some examples, determining the display mode of a subject program (e.g., an application program), such as at 616, may be performed by a different program (e.g., an operating system) of the computing device. However, in other examples, the subject program for which the display mode is determined at 616 may determine the display mode. For example, the pose of the computing device may be communicated to an application program (as the subject program) from the operating system via an application programming interface (API) of the operating system to enable the application program to determine the display mode of the application program at 616. In examples where operations 602 and/or 616 are performed by the subject program, sensor input 642 may be received by the subject program via an API of an operating system of the computing device.

At 630, user input 644 received by the computing device may be detected, and the computing device at 632 may determine whether the initial display mode for the program is to be changed responsive to the user input. Examples of user input described in further detail with reference to FIGS. 7-10 may include a spanning user input that directs the computing device to change the display mode of the subject program from a single display to a double display mode, a contracting user input that directs the computing device to change the display mode of the subject program from a double display mode to a single display mode, a keyboard engagement or disengagement user input, or other suitable user input.

If the initial display mode is determined not to be changed responsive to the user input, the process flow may return to 630. If the initial display mode is determined to be changed responsive to the user input, the process flow may proceed to 638.

In at least some examples, the computing device may reference a set of predefined relationship definitions between user inputs, poses, and display modes to determine whether the display mode is to be changed responsive to a given user input. These relationship definitions may prescribe one or more display modes of the set of available display modes for each user input and pose combination of the set of available poses. Additionally, in at least some examples, these relationship definitions may prescribe a display mode based on the initial display mode, thereby causing the computing device to determine the display mode based, at least in part, on the initial display mode (e.g., current display mode). Examples of this approach are described in further detail with reference to FIG. 7. As part of operation 632, the computing device may compare the initial display mode determined at 616 to the display mode prescribed by the relationship definitions for the given sensor input and initial pose to determine whether the initial display mode corresponds to the prescribed display mode.

Operations 630 and 632 may be performed by the subject program for which the display mode is determined or by a different program (e.g., an operating system) executed by the computing device. By an operating system of the computing device performing operations 630 and 632, scheduling and coordination among multiple application programs may be provided with respect to display availability for the displays of the computing device. In examples where operations 630 and/or 632 are performed by the subject program, the user input may be received by the subject program via an API of an operating system of the computing device.

In combination with operations 630 and 632, a change of pose of the computing device may be detected at 634 based on sensor input 642 received by the computing device. At 636, the computing device determines whether the initial display mode for the program is to be changed responsive to the change of pose detected at 634. As previously described with reference to operation 602, the computing device may reference a set of predefined pose definitions to determine whether the pose has changed responsive to a given sensor input. As part of operation 636, the computing device may compare the initial pose determined at 602 to the pose defined by the pose definitions for the given sensor input to determine whether the initial pose corresponds to the defined pose.

If the initial pose is determined not to be changed responsive to the sensor input, the process flow may return to 634. If the initial pose is determined to be changed responsive to the sensor input, the process flow may proceed to 638.

Operations 634 and 636 may be performed by the subject program for which the display mode is determined or by a different program (e.g., an operating system) executed by the computing device. By an operating system of the computing device performing operations 634 and 636 on behalf of the subject program, application developers may develop application programs across a variety of different computing devices without knowledge of the available poses supported by the hardware configurations of such devices. In examples where operations 634 and/or 636 are performed by the subject program, the sensor input may be received by the subject program via an API of an operating system of the computing device.

At 638, an updated display mode for the subject program may be determined by the computing device responsive to the change of pose and/or the user input prescribing the change to the display mode. Determining the updated display mode for the subject program may include selecting the updated display mode from among a set of available display modes 618, such as previously described with reference to operation 616.

In at least some examples, some display modes may not be available for certain poses. In one example, when the computing device is in the single-portrait pose, the user interface(s) of the program may be displayed in the single-portrait mode using one of the displays. For portrait modes, the user interface has a width that is smaller than its height. As another example, when the computing device is in a single-landscape pose, the user interface(s) of the program may be displayed in the single-landscape mode. For landscape modes, the user interface has a width that is greater than its height. If the device is in the double-portrait pose, the user interface(s) of the program may be displayed in the single-portrait mode or the double-portrait mode, depending on implementation and/or user interaction. If the device is in the double-landscape pose, the user interface(s) of the program may be displayed in the single-landscape mode or the double-landscape mode, depending on implementation and/or user interaction. FIG. 7 provides an example of how the various display modes may be used for different device poses.

At 640, one or more user interfaces of the subject program are displayed in the updated display mode via one or more of the displays of the computing device.

FIG. 7 shows example graphical user interfaces being displayed according to a variety of different display modes for a variety of different poses of the dual display computing device of FIG. 1. As previously described, a user may manipulate the computing device to selectively choose whether to utilize a focus user interface of a subject program to focus on certain content of the program, and whether to utilize a context user interface of the program alongside the focus user interface or instead utilize the focus user interface across two display of the computing device.

In example 700 of FIG. 7, computing device is shown in the double-portrait pose (e.g., 608 of FIG. 6). Computing device 100 executes a subject program comprising a context user interface 702 and a focus user interface 704 that are both displayed via first display 108 in example 700, while a user interface 706 of another program is displayed via second display 110. For example, user interface 706 may be a desktop of an operating system or a user interface of another application program that differs from the subject program. Example 700 corresponds to the single-portrait mode (e.g., 620 of FIG. 6) in which a single display (e.g., first display 108) of computing device 100 is available to the subject application program for presentation of its one or more user interfaces in a portrait orientation, while user interfaces of the subject application are not displayed on the other display (e.g., second display 110) of the computing device. In at least some examples, the single-portrait mode may be initiated upon launch of the subject program. Example 700 shows the context user interface 702 displayed on the right side of focus user interface 704, but in other examples, focus user interface 704 may be on the right side and context user interface 702 may be on the left side (e.g. for a language that is written right-to-left).

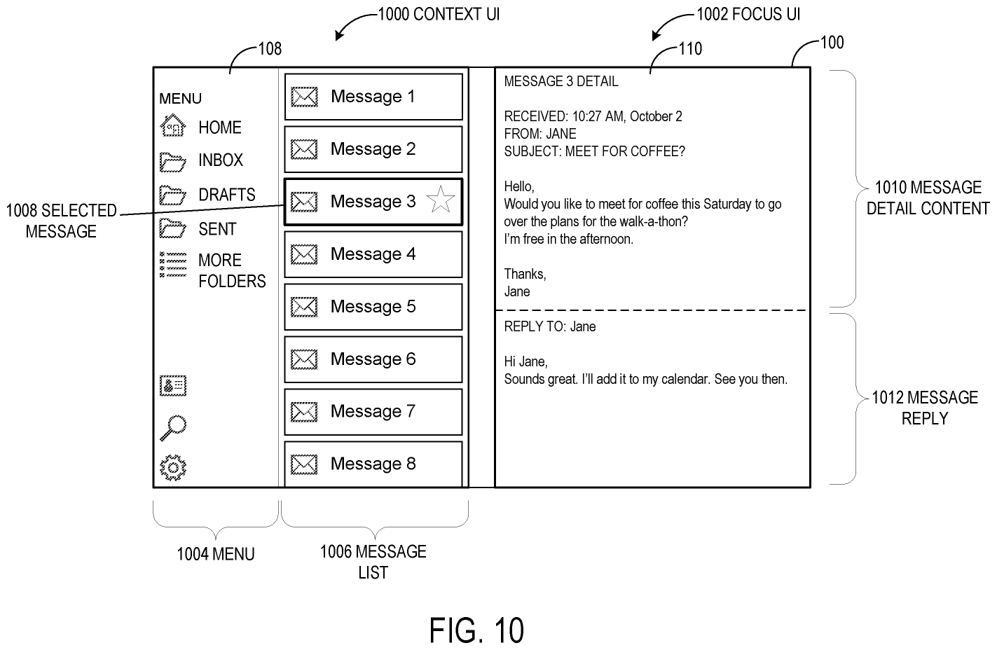

In at least some examples, focus user interface 704 is configured to provide a more detailed view of a selected item from the context user interface 702, as described in further detail with reference to FIG. 10. As one example, the context user interface may comprise a message list and the focus user interface may comprise the contents of a selected message from the message list for an email program or a messaging program. Furthermore, in at least some examples, only one of the context user interface 702 or the focus user interface 704 may be displayed in the single-portrait mode upon launch of the application. The user may toggle between displaying one or more of the user interfaces of the subject program by providing a user input to the computing device.

Upon receipt of a spanning user input, as an example of previously described user input 644 of FIG. 6, computing device 100 determines that the display mode is to be changed from the single-portrait mode to the double-portrait mode (e.g., 622 of FIG. 6) as show in example 710. In this example, for the double-portrait mode, context user interface 702 is displayed on one of the displays (e.g., first display 108) and focus user interface 704 of the subject program is displayed on another of the displays (e.g., second display 110) of computing device 100. By use of the spanning user input, a user may direct computing device 100 to make an additional display available for user interfaces of the subject program, thereby enabling two user interfaces of the program to be viewed side-by-side.

Examples of a spanning user input may include a touch input such as a gesture, a set of one or more taps, or a user selection of a graphical selector displayed by the computing device, or other suitable user input. A gesture may include one or more touch inputs that include dragging of a user interface (e.g., 702 or 704) of the subject program toward or onto a target display (e.g., second display 110) that is not initially displaying user interfaces of the program, swiping or flicking a user interface of the program toward the target display, etc. One or more taps on a user interface of the subject program and/or one or more taps on the target display that is not initially displaying user interfaces of the program are other examples of a spanning user inputs. Yet further examples of spanning user inputs may include a voice command received via a microphone of the computing device or a gesture performed within view of a camera of the computing device. Further, a graphical selector for receiving a spanning user input may form part of a user interface of the subject program or a user interface (e.g., a tool bar or menu) of an operating system of the computing device, as examples. In at least some examples, the graphical selector may correspond to a particular function that is invoked responsive to selection of the graphical selector, such as a “compose” selector that enables a user to compose a message or a “reply” selector that enables a user to reply to another message. In these examples, focus user interface 704 may include a message editor interface that enables a user to compose or edit a message.

A user may provide a contracting user input to computing device 110, as another example of user input 644, to change the display mode from the double-portrait mode of example 710 to the single-portrait mode of example 700. The contracting user input may include any of the examples previously described for the spanning user input or may include a different type of user input. As an example, a contracting user input may include a gesture in an opposite direction from a gesture of the spanning user input.

In response to rotation of computing device 100 from the double-portrait pose of example 710 to the double-landscape pose (e.g., 612 of FIG. 6) of example 712, computing device 100 determines an updated display mode that corresponds to the double-landscape mode (e.g., 626 of FIG. 6). As part of this transition to the double-landscape pose from the double-portrait pose, the orientation of one or more user interfaces of the subject program may be changed from a portrait orientation to a landscape orientation.

In example 712, the double-landscape mode includes focus user interface 704 being displayed across both first display 108 and second display 110 in a landscape orientation. For example, a first portion 704A of the focus user interface is displayed on first display 108 and a second portion 704B of the focus user interface is display on second display 110. The double-landscape mode enables the user to utilize the combined display region of both displays to interact with a particular user interface. In other examples, context user interface 702 may instead be displayed across both displays or each display may present a different user interface of the subject program in a landscape orientation while operating in the double-landscape mode.

In response to rotation of computing device 100 from the double-landscape pose of example 712 to the double-portrait pose of example 710, the computing device may revert to displaying user interfaces of the subject program in the double-portrait mode. As part of this transition to the double-portrait pose from the double-landscape pose, the orientation of one or more user interfaces of the subject program may be changed from a landscape orientation to a portrait orientation.

While computing device 110 is in the double-landscape pose, a contracting user input may be provided by a user to change the display mode for the subject program from the double-landscape mode to the single-landscape mode (e.g., 624) shown in example 714. Conversely, a spanning user input may be provided by a user to change the display mode for the subject program from the single-landscape mode of example 714 to the double-landscape mode of example 712. The spanning user input and contracting user input used to change between the double-landscape mode and the single-landscape mode may include any of the examples previously described with reference to transitions between the single-portrait mode and the double-portrait mode of examples 700 and 710.

In example 714, the context user interface 702 and the focus user interface 704 are displayed on a single display (e.g., first display 108), and another user interface (e.g., 706) of a different program may be displayed on the other display (e.g., second display 110). In other examples, one of context user interface 702 or focus user interface 704 may be displayed at a given time while operating in the single-landscape mode.

While operating in the single-landscape mode of example 714, in response to rotation of computing device 110 from the double-landscape pose to the double-portrait pose of example 700, the computing device changes the display mode of the subject program to the single-portrait mode of example 700. As part of this transition to the double-portrait pose from the double-landscape pose, the orientation of the user interfaces of the subject program may be changed from a landscape orientation to a portrait orientation. Conversely, while operating in the single-portrait mode of example 700, in response to rotation of computing device 110 from the double-portrait pose to the double-landscape pose of example 714, the computing device changes the display mode of the subject program to the single-landscape mode of example 714. As part of this transition, the orientation of the user interfaces of the subject program may be changed from a portrait orientation to a landscape orientation.

In at least some examples, additional display modes beyond those described with reference to FIG. 7 may be provided. FIG. 8 shows example graphical user interfaces being displayed for a hardware or software keyboard that is engaged with respect to a computing device, such as computing device 100 of FIG. 1. Within FIG. 8, an example 800 is shown in which a keyboard display mode is provided by computing device 100 in response to a keyboard 810 being engaged with respect to the computing device 100.

In examples where keyboard 810 is a software keyboard, at least a portion of a display (e.g., second display 110) of computing device 100 is used to display the keyboard. For example, a user may engage the software keyboard via a user input provided to a graphical selector displayed by the computing device. In examples where keyboard 810 is a hardware keyboard, a rear surface of the keyboard may be placed in contact with a display (e.g., second display 110) of the computing device.

In example 800, keyboard 810 occupies less than the entire display region of second display 110. A region of second display 110 not occupied by keyboard 810 may be used to display an augmented user interface 802. Augmented user interface 802 may replace a portion (e.g., 704B) of focus user interface while operating in the previously described double-landscape mode of example 712 of FIG. 7. For example, in response to engagement of keyboard 810, the computing device may display the focus user interface on the other display (e.g., the upper portion comprising the first display).

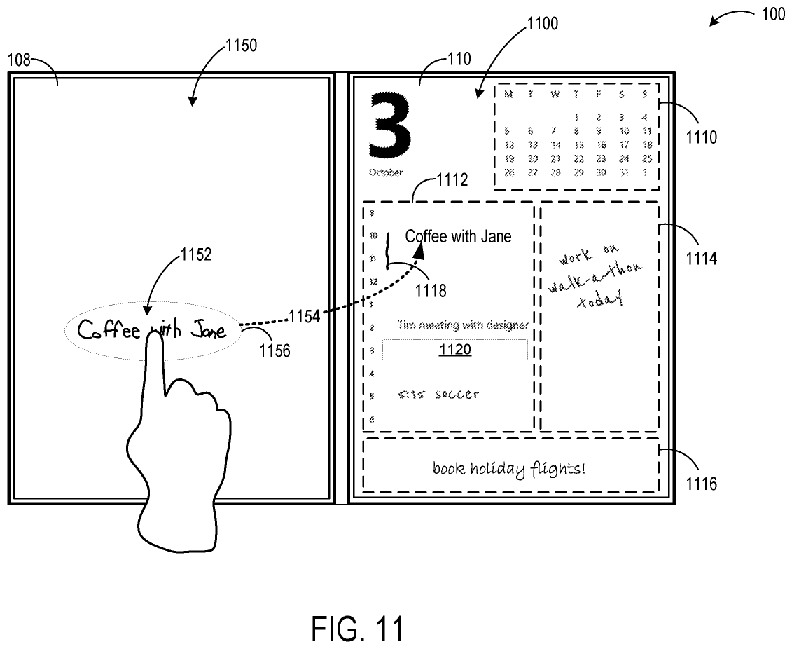

In some examples, the computing device may display additional content of the focus user interface on the visible part of the second display that is not covered by the keyboard. In other examples, the program may display augmented user interface 802. User interface 802 may include an inking interface (e.g., as described with reference to FIG. 11), a menu bar interface, a multi-purpose taskbar interface, or other content. Additional inputs, such as inking inputs received via an inking interface, described in further detail with reference to FIG. 11, may be accepted by the computing device in one or both of the context user interface and the focus user interface. Some programs may be configured to receive inking inputs at any time. Other programs may receive inking inputs only after a user requests and inking input interface. After providing the inking input, the user may drag the displayed ink to another destination on one of the displays of the device 100. In one example, a user interacting with a messaging program may drag an inking input, e.g., a signature, to include in a message.

In at least some examples, keyboard 810, when taking the form of a hardware keyboard, may communicate wirelessly with computing device 100. The hardware keyboard may, for example, may be removably attached to computing device 100 such as via magnetic attachment, physical electronic connector, snapping to the enclosure of the computing device, or other suitable attachment mechanism. FIG. 8 depicts an example in which keyboard 810 as hardware keyboard 810A is rotatably connected to second portion 104 of computing device 100 via a hinge 812. In some examples, the keyboard may be configured such that it can be rotated and stored behind either the first portion or second portion of the computing device opposite their respective displays. Hinge 812 may include an associated hinge sensor 814 that can be used by computing device 100 to detect whether the keyboard is engaged or disengaged based on a measured angle being within a defined range. Hardware keyboard 810A may include an orientation sensor 816 that can be used by computing device 100 to detect whether the keyboard is engaged or disengaged based on a measured orientation of the keyboard being within a defined range. A rear surface 818 of hardware keyboard 810A is depicted in FIG. 8. Rear surface 818 may include a physical identifier (e.g., a capacitive feature) that can be detected via a touch sensor of a touch-sensitive display, such as display 110 to determine whether the keyboard is engaged or disengaged with respect to the computing device.

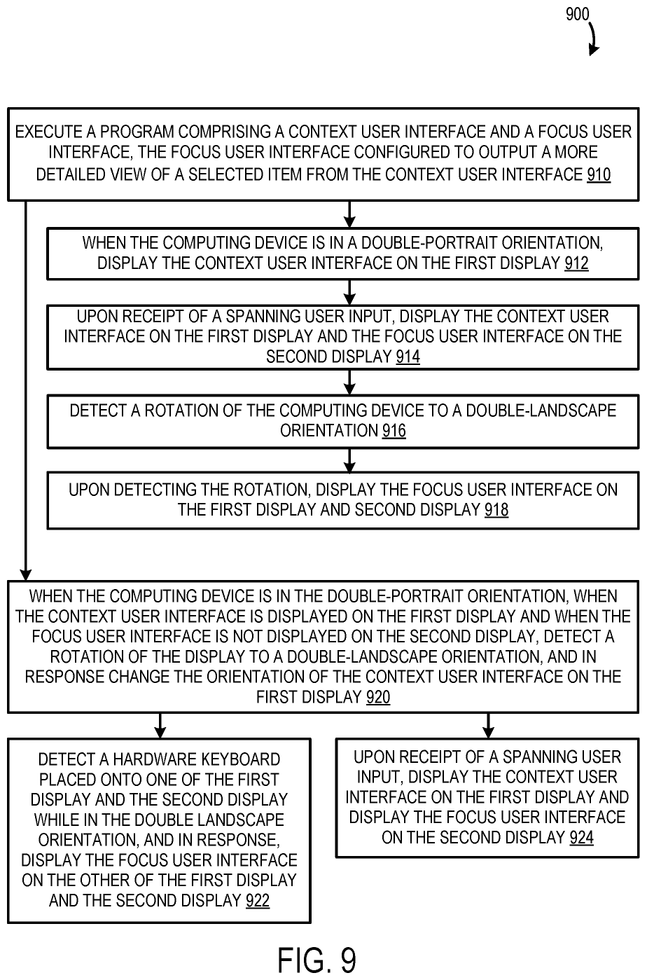

FIG. 9 shows a flow diagram of an example method 900 of displaying a context user interface and a focus user interface on a computing device, such as computing device 100 of FIG. 1 based on a user input and rotation of the computing device. Method 900 provides an example implementation of method 600 of FIG. 6 that may utilize the various device poses and display modes of FIGS. 7 and 8.

At 910, the method may include executing a program comprising a context user interface and a focus user interface in which the focus user interface configured to output a more detailed view of a selected item from the context user interface. As an example, the method at 902 may include executing an email program or a messaging program.

At 912, the method may include, when the computing device is in a double-portrait orientation corresponding to the double-portrait pose (e.g., 608 of FIG. 6), displaying the context user interface on the first display (e.g., as depicted in example 700 of FIG. 7). The context user interface may be displayed on the first display with or without the focus user interface, as previously described with reference to FIG. 7.

At 914, the method may include, upon receipt of a spanning user input, display the context user interface on the first display and the focus user interface on the second display (e.g., as depicted in example 710 of FIG. 7).

At 916, the method may include detecting a rotation of the computing device to a double-landscape orientation corresponding to the double-landscape pose (e.g., as depicted in example 712 of FIG. 7).

At 918, the method includes, upon detecting the rotation, displaying the focus user interface on the first display and second display (e.g., as depicted in example 712 of FIG. 7).

As an alternative process flow from operation 910, the method at 920 may include when the computing device is in the double-portrait orientation corresponding to the double-portrait pose, when the context user interface is displayed on the first display and when the focus user interface is not displayed on the second display, detecting a rotation of the display to a double-landscape orientation corresponding to the double-landscape pose, and in response changing the orientation of the context user interface on the first display (e.g., as depicted in example 714 of FIG. 7).

The method at 916 may further include, detecting a hardware keyboard placed onto one of the first display and the second display while in the double landscape orientation, and in response, displaying the focus user interface on the other of the first display and the second display (e.g. as depicted in example 800 of FIG. 8).

As another example, at 924, the method may include, upon receipt of a spanning user input, displaying the selected item in the focus user interface across the first display and the second display (e.g., as depicted in example 710 of FIG. 7).

FIG. 10 shows an example of a context user interface 1000 and a focus user interface 1002 of an email or messaging application program. Context user interface 1000 is an example of previously described context user interface 702, and focus user interface 1002 is an example of previously described focus user interface 704 of FIG. 7.

Within FIG. 10, computing device 100 is displaying user interfaces 1000 and 1002 in a double-portrait mode while the computing device is configured to have a double-portrait pose. In this example, the context user interface 1000 includes a menu 1004 (e.g., a folder list) and a message list 1006. Menu 1004 may allow a user to search for messages or to navigate to different folders to display a different message list. The user may select a message (e.g., “Message 3”, selected message 1008) from message list 1006 to display message details within focus user interface 1002. Selected message 1008 may be displayed with a visual indicator, such as an icon, a highlight, a different background color, a different font, other indicator, or combination of indicators.

Within focus user interface 1002, message detail content 1010 is displayed in an upper region of the focus user interface for selected message 1008. The program may initiate an authoring experience in response to a user input. In this example, the user has provided a user input to reply to selected message 1008, and has begun composing a message reply 1012 in the lower portion of focus user interface 1002. In some examples, the user may compose the response via a hardware keyboard. In other examples, the email program may display a software keyboard to enable the user to compose the message reply, such as depicted in FIG. 8.

A touch-sensitive display device, such as example computing device 100 of FIG. 1 can be used to interact with other types of programs in a manner that provides improved user experience and productivity. FIG. 11 shows an example graphical user interface 1100 of a calendar program executed by computing device 100 for which a calendar item is created or modified by an inking input. In this example, user interface 1100 is displayed on second display 110 and an inking interface 1150 of an inking program executed by computing device 100 for receiving an inking input is displayed on first display 108. In other examples, user interface 1100 is displayed on first display 108 and the inking interface 1150 is displayed on second display 110.

User interface 1000 of the calendar program may comprise a daily agenda, schedule, weekly calendar view, monthly calendar view, or other view. The program may allow a user to navigate to a selected date. User interface 1000 includes a calendar region 1110, daily schedule region 1112, a daily notes region 1014, and a tasks region 1116. User interface 1110 may display calendar information, including calendar items. A calendar item may be an event, an appointment, a meeting, an all-day event, a task item, or other such item. All-day events may be associated with a particular date in the calendar. An appointment may have a set time and date. Some calendar items may also have a duration. Some calendar items may have a due date and/or time. Meetings may have a list of participants associated with the calendar item.

The calendar program may receive an inking input via inking interface 1150 related to a new calendar item to be created. In this example, the user has inked “coffee with Jane” as an example inking input 1152 by moving a finger over the display, which is detected via a touch sensor associated with the display. Alternatively, a stylus or other implement may be used to provide inking input 1152.

The user may provide a user input in the form of a dragging input 1154, whereby the user drags inking input 1152 from inking interface 1150 on first display 108 to the calendar interface 1100 on second display 110. Touch sensors associated with the displays enable the computing device to detect and track the user's interaction with inking input 1152 over the duration of the dragging input. The calendar program may be configured to create a new calendar item or modify an existing calendar item based on a destination position of the dragging input. In this example, the destination position of dragging input 1154 is within schedule region 1112.

After a calendar item has been created, the calendar item is displayed on the calendar interface. The inking input may be interpreted and/or parsed and displayed as text within the calendar interface, such as depicted within schedule region 1112 of this example. In at least some examples, inking inputs may be interpreted by an inking interpreter that forms an ink-to-text program or program component of either the inking program or the calendar program to identify inking terms relevant to the calendar program, such as a subject/event title, a time, a location, names, or other relevant terms.

In another example, calendar items created via inking inputs may be displayed in such a way as to distinguish the calendar item from other calendar items created via other methods. For example, the calendar item text may comprise a script font which may further comprise a personalized scripted font based on a user's handwriting. Upon creating the calendar item, the original inking input may be stored (e.g., as an image file) with the calendar item. The inking input may be visible if a user selects the calendar item to view or further modify the calendar item details.

As additional examples, the user may circle, or draw a bounding region 1156 around the inking input to distinguish the desired input from other inking inputs of the inking interface. The calendar program may be configured to receive additional inking inputs within bounding region 1156 which encompasses and defines the intended inking inputs. In this example, the inking interpreter will not consider inking outside the bounding region.

The calendar item may be created based upon inking terms identified by the inking interpreter. In one example, the inking interpreter may identify a time term and in response, the calendar program creates an event at the time or a task item due at the time. In another example, the inking interpreter may identify a name of a person and in response, the calendar program creates a meeting that includes an invitation for the identified person. In yet another example, the inking interpreter may identify a time duration and in response, the calendar program may create an event lasting from a start time to an end time based on the identified time duration term.

In a previously described example, if the inking input is dragged to schedule region 1110 of the calendar interface, the calendar program may create a calendar event. In this scenario, the time of the event may be further based upon the destination position within schedule region 1110. If the user wishes to schedule the “coffee with Jane” event at 3:00 pm instead of 10:00 am, the user may drag the inking input to a corresponding region 1120. In another example, the user may drag the inking input to the daily notes region 1114. In this scenario, the calendar program may instead create an all-day event based upon the destination position being within the daily notes region 1114.

In another example, the user may drag the inking input to the tasks region 1116. In this scenario, the calendar program may create a task item based upon the destination region being within the tasks region 1116. As discussed above, the identified inking terms such as a time and a name of the task may be created that is due at the specified time. Furthermore, the inking interpreter or calendar program may interpret a time as an “end time” or “due date” rather than an event start time based at least upon the destination position being within the tasks region 1114.

The calendar program may accept additional inputs to modify an event after an event has been created. The example in FIG. 11 shows the schedule region divided up into 1-hour time blocks. If a user wants to create an event for a different time duration, the user may provide additional inputs after creating the event. In one example, the user may draw a vertical line 1118 to indicate the 10:00 am-11:00 am block and the 11:00 am-12:00 pm block, thus indicating that the “Coffee with Jane” event is from 10:00 am-12:00 pm.

A user may desire to create a calendar item for a different date other than the current selected date associated with the displayed daily agenda. Thus, a user may drag the inking input to the calendar region 1110. The destination position may be a new selected date within the calendar region. In this scenario, the calendar program may create the calendar item for the selected date. For example, the user may drag the inking input 1152 to the calendar region 1110 to destination position corresponding to October 4^{th} to create the “Coffee with Jane” event on October 4^{th}. As discussed above, the inking interpreter may identify a time in the inking input, in which case the event may be created for that time by the calendar program on the selected date.

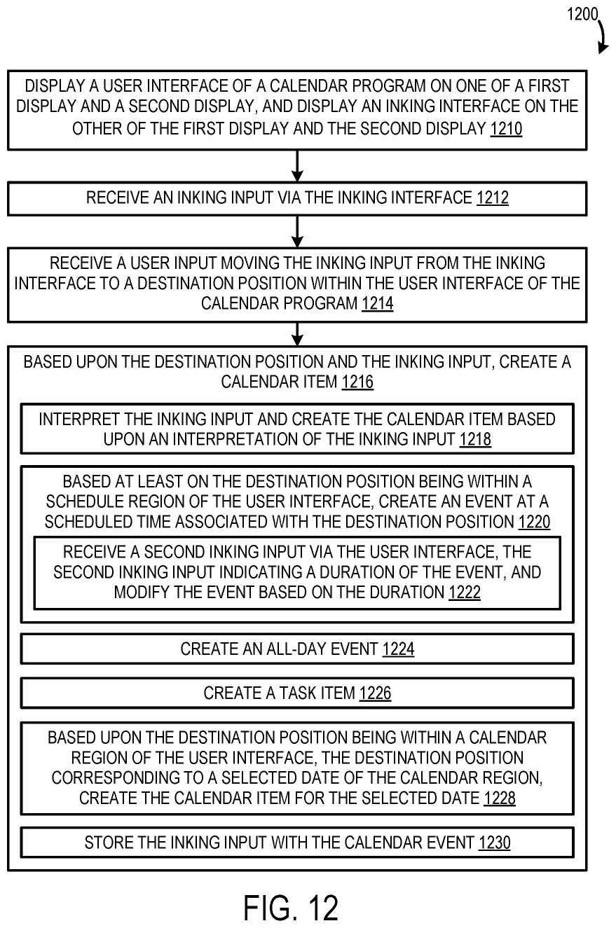

FIG. 12 shows a flow diagram of an example method 1200 of creating or modifying a calendar item by using an inking input. Method 1200 may be performed by computing device 100 of FIG. 1, as an example.

At 1210, the method includes displaying a user interface of a calendar program on one of a first display and a second display, and displaying an inking interface on the other of the first display and the second display. Inking interface 1150 of FIG. 11 is one example of an inking interface by which an inking input may be received. As another example, an inking interface may be integrated within the user interface of the calendar program.

At 1212, the method includes receiving an inking input via the inking interface. For example, a user may provide a touch input to a display of the computing device, such as handwriting text with a finger or stylus.

At 1214, the method includes receiving a user input moving the inking input from the inking interface to a destination position within the user interface of the calendar program. In an example, the user input includes a dragging input. As additional examples, the user input may include one or more taps indicating the inking input and/or the destination position, a flick or swipe gesture directed at the inking input and moving toward the destination position, a user selection of one or more graphical selectors, or other suitable user input.

At 1216, the method includes creating a calendar item based on the destination position of the inking input. The destination position may be located within one of example calendar regions previously described with reference to FIG. 11.

In some examples, the method may include at 1218, interpreting the inking input and creating the calendar item based upon an interpretation of the inking input. As previously described with reference to FIG. 11, an ink-to-text program or program component may be used to interpret the inking input for use by the calendar program.

In some examples, the method may include at 1220, based at least on the destination position being within a schedule region of the user interface, creating an event at a scheduled time associated with the destination position.

In some examples, the method may include, at 1222, receiving a second inking input via the user interface of the calendar program. The second inking input may indicate a duration of the event, and the event may be modified based on the duration.

In some examples, the method may include, at 1224, creating an all-day event. For example, the all-day event may be created responsive to the destination position being within a predefined region (e.g., 1114 of FIG. 11) of the user interface of the calendar program.

In some examples, the method may include, at 1226, creating a task item. For example, the task item may be created responsive to the destination position being within a predefined region (e.g., 1116 of FIG. 11) of the user interface of the calendar program.

In some examples, the method includes, at 1228, based upon the destination position being within a calendar region (e.g., 1110) of the user interface, creating the calendar item for a selected date corresponding to the destination position.

In some examples, the method further includes, at 1230, storing the inking input with the calendar event. For example, the inking input may be stored as an image file that is associated with the calendar event within a database system accessible to the calendar program.

In some at least some examples, the methods and processes described herein may be tied to a computing system of one or more computing devices. In particular, such methods and processes may be implemented as one or more computer programs executed by the computing system.

FIG. 13 schematically shows an example computing system 1300 that can enact one or more of the methods and processes described above. Computing system 1300 is shown in simplified form. Computing system 1300 may take the form of one or more computing devices. Computing devices of computing system 1300 may include one or more personal computing devices, server computing devices, tablet computing devices, mobile computing devices, mobile communication devices (e.g., smart phone), home-entertainment computing devices, network computing devices, electronic gaming devices, and/or other computing devices, as examples. Computing device 100 of FIG. 1 is an example of computing system 1300.

Computing system 1300 includes a logic subsystem 1310, a storage subsystem 1312, and an input/output subsystem 1314. Computing system 1300 may further include a communication subsystem 1316 and/or other components not shown in FIG. 13.

Logic subsystem 1310 includes one or more physical devices configured to execute instructions. For example, the logic subsystem may be configured to execute instructions 1320 stored in storage subsystem 1312. Such instructions may be implemented to perform a task (e.g., perform methods 600, 900, and 12 of FIGS. 6, 9, and 12), implement a data type, transform the state of one or more components, achieve a technical effect, or otherwise arrive at a desired result. As an example, the logic subsystem may include one or more processors configured to execute software instructions. Additionally or alternatively, the logic subsystem may include one or more hardware or firmware logic machines configured to execute hardware or firmware instructions. Processors of the logic subsystem may be single-core or multi-core, and the instructions executed thereon may be configured for sequential, parallel, and/or distributed processing. Individual components of the logic subsystem optionally may be distributed among two or more separate devices, which may be remotely located and/or configured for coordinated processing. As an example, first portion 102 and second portion 104 of computing device 100 may each include a processor of logic subsystem 1310. As another example, one of first portion 102 or second portion 104 may include the logic subsystem. Aspects of the logic subsystem may be virtualized and executed by remotely accessible, networked computing devices configured in a cloud-computing configuration.

Storage subsystem 1312 includes one or more physical devices configured to hold instructions 1320 and/or other data 1322 executable by the logic subsystem to implement the methods and processes described herein. When such methods and processes are implemented, the state of storage subsystem 1312 may be transformed—e.g., to hold different data.

Storage subsystem 1312 may include removable and/or built-in devices. Storage subsystem 1312 may include optical memory (e.g., CD, DVD, HD-DVD, Blu-Ray Disc, etc.), semiconductor memory (e.g., RAM, EPROM, EEPROM, etc.), and/or magnetic memory (e.g., hard-disk drive, floppy-disk drive, tape drive, MRAM, etc.), among others. Storage subsystem 1312 may include volatile, nonvolatile, dynamic, static, read/write, read-only, random-access, sequential-access, location-addressable, file-addressable, and/or content-addressable devices.

It will be appreciated that storage subsystem 1312 includes one or more physical devices. However, aspects of the instructions described herein alternatively may be propagated by a communication medium (e.g., an electromagnetic signal, an optical signal, etc.) that is not held by a physical device for a finite duration. Aspects of logic subsystem 1310 and storage subsystem 1312 may be integrated together into one or more hardware-logic components. Such hardware-logic components may include field-programmable gate arrays (FPGAs), program- and application-specific integrated circuits (PASIC/ASICs), program- and application-specific standard products (PSSP/ASSPs), system-on-a-chip (SOC), and complex programmable logic devices (CPLDs), for example.

Examples of instructions 1320 are depicted in further detail in FIG. 13 as including an operating system 1324 and one or more application programs 1326. In this example, application programs 1326 include an email program 1330, a message program 1332, a calendar program 1334, an inking program 1336, and one or more other programs 1338 (e.g., a separate ink-to-text program). Application programs 1326 may communicate with operating system 1324 via an API 1328, which may form part of the operating system.

The terms “module,” “program,” and “engine” may be used to describe an aspect of computing system 1300 implemented to perform a particular function. In some cases, a module, program, or engine may be instantiated via logic subsystem 1310 executing instructions held by storage subsystem 1312. It will be understood that different modules, programs, and/or engines may be instantiated from the same operating system, application program, service, code block, object, library, routine, API, function, etc. Likewise, the same module, program, and/or engine may be instantiated by different operating systems, application programs, services, code blocks, objects, routines, APIs, functions, etc. The terms “module,” “program,” and “engine” may encompass individual or groups of executable files, data files, libraries, drivers, scripts, database records, etc.

Input/output subsystem 1314 may include one or more input devices and/or one or more output device. Examples of input and/or output devices include a first display 1340 of which first display 108 of FIG. 1 is an example, a first touch sensor 1342 that is associated with first display 1340 to detect touch input via the first display, a first orientation sensor 1344 associated with first display 1340 to detect an orientation or a change in orientation (e.g., rotation) of the first display, a second display 1346 of which second display 110 of FIG. 1 is an example, a second touch sensor 1348 that is associated with second display 1346 to detect touch input via the second display, a second orientation sensor 1350 associated with second display 1346 to detect an orientation or a change in orientation (e.g., rotation) of the second display, a hinge sensor 1352 associated with a hinge that connects portions of a computing device that include first display 1340 and second display 1346 to detect an relative angle between the first display and second display, a keyboard 1354 (a hardware keyboard), one or more other input devices 1356 (e.g., a controller, computer mouse, microphone, camera, etc.), and one or more other output devices 1358 (e.g., an audio speaker, vibration/haptic feedback device, etc.).

In an example, computing system 1300 takes the form of a computing device that includes a first portion (e.g., 102 of FIG. 1) comprising first display 1340, first touch sensor 1342, and first orientation sensor 1344; and a second portion (e.g., 104 of FIG. 1) comprising second display 1346, second touch sensor 1348, and second orientation sensor 1350. The second portion may be rotatably connected to the first portion via a hinge with which hinge sensor 1352 is associated. Touch sensors 1342 and 1348 may utilize capacitive, resistive, inductive, optical, or other suitable sensing technology to detect touch inputs at or near the surfaces of displays 1340 and 1346, respectively. Orientation sensors 1344 and 1350 may include inertial sensors, accelerometers, gyroscopes, magnetometers, tilt sensors, or other suitable technology to detect orientation of the displays. Additional orientation sensors (e.g., 816 of FIG. 8) may be included in computing system 1300, for example, to detect an orientation of a hardware keyboard (e.g., 810A of FIG. 8) relative to a portion of the computing device. Hinge sensor 1352 may utilize electro-mechanical (e.g., potentiometer), electromagnetic (e.g., Hall effect), or optical sensing technology to detect an angle of rotation about the hinge between the first portion and the second portion of the computing device. Additional hinge sensors (e.g., 814 of FIG. 8) may be included in computing system 1300, for example, to detect an angle of rotation of a hardware keyboard (e.g., 810 of FIG. 8) relative to a portion of the computing device.

Displays 1340 and 1346 may be used to present a visual representation of data held by storage subsystem 1312. This visual representation may take the form of a graphical user interface (GUI). As the herein described methods and processes change the data held by the storage subsystem, and thus transform the state of the storage subsystem, the state of the displays may likewise be transformed to visually represent changes in the underlying data. The displays may utilize any suitable display technology. Such displays may be combined with logic subsystem 1310 and/or storage subsystem 1312 in a shared enclosure, or such displays may be peripheral display devices in combination with their associated touch sensors.

Other input devices 1356 may comprise or interface with selected natural user input (NUI) componentry. Such componentry may be integrated or peripheral, and the transduction and/or processing of input actions may be handled on- or off-board. Example NUI componentry may include a microphone for speech and/or voice recognition; an infrared, color, stereoscopic, and/or depth camera for machine vision and/or gesture recognition; a head tracker, eye tracker, accelerometer, and/or gyroscope for motion detection and/or intent recognition; as well as electric-field sensing componentry for assessing brain activity.

When included, communication subsystem 1316 may be configured to communicatively couple computing system 1300 with one or more other computing devices. Communication subsystem 1316 may include wired and/or wireless communication devices compatible with one or more different communication protocols. As examples, the communication subsystem may be configured for communication via a wireless telephone network, or a wired or wireless local- or wide-area network. In some embodiments, the communication subsystem may allow computing system 1300 to send and/or receive messages to and/or from other devices via a network such as the Internet. Communication subsystem 1316 may support communications with peripheral input/output devices, such as a wireless peripheral keyboard (e.g., hardware keyboard 810A of FIG. 8) as an example.

Another example provides a computing device comprising a first portion comprising a first display, a second portion comprising a second display, the second portion rotatably connected to the first portion, a logic device, and a storage device holding instructions executable by the logic device to execute a program comprising a context user interface and a focus user interface, the focus user interface configured to provide a more detailed view of a selected item from the context user interface, upon receipt of a spanning user input in a double-portrait orientation, display the context user interface on the first display and the focus user interface on the second display, detect a rotation of the computing device to a double-landscape orientation, and upon detecting the rotation, display the focus user interface on the first display and second display. In some such examples, the program comprises an email program or a messaging program, wherein the context user interface comprises a list of messages, and wherein the focus user interface comprises content from a selected message in the context user interface. In some such examples, the instructions are further executable to, when the computing device is in the double-portrait orientation, when the context user interface is displayed on the first display and when the focus user interface is not displayed on the second display, detect a rotation of the display to a double-landscape orientation, and in response change the orientation of the context user interface on the first display. In some such examples, the instructions are further executable to detect a hardware keyboard placed onto one of the first display and the second display while in the double landscape orientation, and in response, display the focus user interface on the other of the first display and the second display. In some such examples, the instructions are further executable to, upon receipt of a spanning user input in the double-landscape orientation, display the selected item in the focus user interface across the first display and the second display. In some such examples, the spanning input comprises a touch input dragging the context user interface toward the second display. In some such examples, the instructions are further executable to receive an inking input, to receive an input dragging the inking input to a calendar interface of the program, and in response to create a calendar item comprising the inking input.

Another example provides a method enacted on a dual-screen computing device comprising a first portion with a first display and a second portion with a second display, the method comprising executing a messaging program comprising a context user interface and a focus user interface, the context user interface comprising a list of messages and the focus user interface comprising a more detailed view of a selected message from the context user interface; when the computing device is in a double-portrait orientation, causing display of the context user interface on the first display; and upon receipt of a spanning user input and detection of a rotation of the computing device to a double-landscape orientation, causing display of the focus user interface on the first display and second display. In some such examples, the messaging program comprises an email program. In some such examples the method comprises, when the computing device is in the double-portrait orientation and the spanning user input is received, causing display of the context user interface on the first display and causing display of the focus user interface on the second display, and then detecting the rotation of the computing device to the double-landscape orientation and in response causing display of the focus user interface on the first display and the second display. In some such examples, the method comprises, when the computing device is in the double-portrait orientation and the rotation to the double-landscape orientation is detected, causing display of the context user interface and the focus user interface on the first display, then receiving the spanning user input and in response causing display of the focus user interface across the first display and the second display. In some such examples, the method further comprises, when in the double landscape orientation, detecting a hardware keyboard placed on the second display, and in response displaying the focus user interface on the first display.

Another example provides a method enacted on a dual-screen computing device comprising a first portion with a first display and a second portion with a second display. The method comprises executing a communication program comprising a context user interface and a focus user interface, the focus user interface configured to output a more detailed view of a selected message from the context user interface; when the computing device is in a double-portrait orientation, causing display of the context user interface on the first display; upon receipt of a spanning user input in the double-portrait orientation, causing display of the context user interface on the first display and causing display of the focus user interface on the second display; detecting a rotation of the computing device to a double-landscape orientation; and upon detecting the rotation, causing display of the focus user interface on the first display and second display. In some such examples, the context user interface comprises a list of messages. In some such examples, the method further comprises, when the computing device is in the double-portrait orientation, when the context user interface is displayed on the first display and when the focus user interface is not displayed on the second display, detecting a rotation of the display to a double-landscape orientation, and in response causing a change of the orientation of the context user interface on the first display. In some such examples, the method further comprises detecting a hardware keyboard placed onto one of the first display and the second display while in the double landscape orientation, and in response, causing display of the focus user interface on the other of the first display and the second display. In some such examples, the method further comprises, upon receipt of a spanning user input in the double-landscape orientation, causing display of the selected item in the focus user interface across the first display and the second display.

Another example provides a computing device, comprising a first portion comprising a first display, a second portion comprising a second display, the second portion rotatably connected to the first portion, a logic device, and a storage device holding instructions executable by the logic device to display a user interface of a calendar program on one of the first display and the second display, and display an inking interface on the other of the first display and the second display, receive an inking input via the inking interface, receive an input moving the inking input from the inking interface to a destination position within the user interface of the calendar program, and based upon the destination position and the inking input, create a calendar item. In some such examples, the instructions are executable to interpret the inking input and create the calendar item based upon an interpretation of the inking input. In some such examples, the instructions are executable to, based at least on the destination position being within a schedule region of the user interface, create an event at a scheduled time associated with the destination position. In some such examples, the inking input is a first inking input, and the instructions are further executable to receive a second inking input via the calendar interface, the second inking input indicating a duration of the event, and modify the event based on the duration. In some such examples, the instructions are executable to, based at least on the destination position, create an all-day event or a task item. In some such examples, the identified inking terms comprise a time and the instructions are executable to interpret the inking input and create the task item due at the time. In some such examples, the instructions are further executable to, based upon the destination position being within a calendar region of the user interface, the destination position corresponding to a selected date of the calendar region, create the calendar item for the selected date. In some such examples, the instructions are further executable to store the inking input with the calendar item.

It will be understood that the configurations and/or approaches described herein are exemplary in nature, and that these specific embodiments or examples are not to be considered in a limiting sense, because numerous variations are possible. The specific routines or methods described herein may represent one or more of any number of processing strategies. As such, various acts illustrated and/or described may be performed in the sequence illustrated and/or described, in other sequences, in parallel, or omitted. Likewise, the order of the above-described processes may be changed.

The subject matter of the present disclosure includes all novel and non-obvious combinations and sub-combinations of the various processes, systems and configurations, and other features, functions, acts, and/or properties disclosed herein, as well as any and all equivalents thereof.

1. A computing device, comprising:
a first portion of the computing device comprising a first display screen;
a second portion of the computing device comprising a second display screen, the second portion rotatably connected to the first portion by a hinge;
a logic device; and
a storage device holding instructions executable by the logic device to:
execute a program comprising a context user interface and a focus user interface, the focus user interface configured to provide a more detailed view of a selected item from the context user interface,
upon receipt of a spanning user input in a double-portrait orientation, display the context user interface on the first display screen and the focus user interface on the second display screen,
detect a rotation of the computing device to a double-landscape orientation, and
upon detecting the rotation, display the focus user interface on the first display screen and second display screen.

2. The computing device of claim 1, wherein the program comprises an email program or a messaging program, wherein the context user interface comprises a list of messages, and wherein the focus user interface comprises content from a selected message in the context user interface.

3. The computing device of claim 1, wherein the instructions are further executable to, when the computing device is in the double-portrait orientation, when the context user interface is displayed on the first display screen and when the focus user interface is not displayed on the second display screen, detect a rotation of the computing device to a double-landscape orientation, and in response change the orientation of the context user interface on the first display screen.

4. The computing device of claim 3, wherein the instructions are further executable to detect a hardware keyboard placed onto one of the first display screen and the second display screen while in the double-landscape orientation, and in response, display the focus user interface on the other of the first display screen and the second display screen.

5. The computing device of claim 3, wherein the instructions are further executable to, upon receipt of a spanning user input in the double-landscape orientation, display the selected item in the focus user interface across the first display screen and the second display screen.

6. The computing device of claim 1, wherein the spanning user input comprises a touch input dragging the context user interface toward the second display screen.

7. The computing device of claim 1, wherein the instructions are further executable to receive an inking input, to receive an input dragging the inking input to a calendar interface of the program, and in response to create a calendar item comprising the inking input.

8. A method enacted on a dual-screen computing device comprising a first portion of the computing device with a first display screen and a second portion of the computing device with a second display screen, the second portion rotatably connected to the first portion by a hinge, the method comprising:
executing a messaging program comprising a context user interface and a focus user interface, the context user interface comprising a list of messages and the focus user interface comprising a more detailed view of a selected message from the context user interface;
when the computing device is in a double-portrait orientation, causing display of the context user interface on the first display screen; and
upon receipt of a spanning user input and detection of a rotation of the computing device to a double-landscape orientation, causing display of the focus user interface on the first display screen and second display screen.

9. The method of claim 8, wherein the messaging program comprises an email program.

10. The method of claim 8, wherein, when the computing device is in the double-portrait orientation and the spanning user input is received, causing display of the context user interface on the first display screen and causing display of the focus user interface on the second display screen, and then detecting the rotation of the computing device to the double-landscape orientation and in response causing display of the focus user interface on the first display screen and the second display screen.

11. The method of claim 8, wherein, when the computing device is in the double-portrait orientation and the rotation to the double-landscape orientation is detected, causing display of the context user interface and the focus user interface on the first display screen, then receiving the spanning user input and in response causing display of the focus user interface across the first display screen and the second display screen.

12. The method of claim 8, further comprising, when in the double-landscape orientation, detecting a hardware keyboard placed on the second display screen, and in response displaying the focus user interface on the first display screen.

13. A computing device, comprising:
a first portion of the computing device comprising a first display screen;
a second portion of the computing device comprising a second display screen, the second portion rotatably connected to the first portion via a hinge;
a logic device; and
a storage device holding instructions executable by the logic device to:
display a user interface of a calendar program on one of the first display screen and the second display screen, and display an inking interface on the other of the first display screen and the second display screen,
receive an inking input via the inking interface,
receive an input moving the inking input from the inking interface to a destination position within the user interface of the calendar program, and
based upon the destination position and the inking input, create a calendar item.

14. The computing device of claim 13, further comprising instructions executable to interpret the inking input and create the calendar item based upon an interpretation of the inking input.

15. The computing device of claim 13, wherein the instructions are executable to, based at least on the destination position being within a schedule region of the user interface, create an event at a scheduled time associated with the destination position.

16. The computing device of claim 15, wherein the inking input is a first inking input, and wherein the instructions are further executable to receive a second inking input via the user interface, the second inking input indicating a duration of the event, and modify the event based on the duration.

17. The computing device of claim 13, wherein the instructions are executable to, based at least on the destination position, create an all-day event or a task item.

18. The computing device of claim 13, wherein the identified inking terms comprise a time and wherein the instructions are executable to interpret the inking input and create a task item due at the time.

19. The computing device of claim 13, wherein the instructions are further executable to, based upon the destination position being within a calendar region of the user interface, the destination position corresponding to a selected date of the calendar region, create the calendar item for the selected date.

20. The computing device of claim 13, wherein the instructions are further executable to store the inking input with the calendar item.
